(19) United States
(12) Patent Application Publication
(10) Pub. No.: US 2007/0280593 A1
(43) Pub. Date: Dec. 6, 2007

(54) HIGH CONTRAST EDGE-LIT SIGNS AND IMAGES

(75) Inventors: Joseph G. Brychell, Ponte Vedra Beach, FL (US); Douglas A. Nutter, Monrovia, VA (US); Thomas L. Davenport, Tucson, AZ (US); William J. Cassarly, Wooster, OH (US)

Correspondence Address: KNOBBE MARTENS OLSON & BEAR LLP, 2040 MAIN STREET, FOURTEENTH FLOOR, IRVINE, CA, 92614, US

(73) Assignee: Optical Research Associates, Pasadena, CA (US)

(21) Appl. No.: 11/751,579

(22) Filed: May 21, 2007

Related U.S. Application Data
(63) Continuation-in-part of application No. 11/267,945, filed on Nov. 4, 2005, now Pat. No. 7,277,609.
(60) Provisional application No. 60/802,482, filed on May 22, 2006.

(51) Int. Cl. G02B 6/26

(52) U.S. Cl. 385/31

(57) ABSTRACT

Various embodiments are described that provide a techniques to produce sharp, high contrast, edge enhanced images using edge-lit displays. The edge-lit displays may comprise extractor pattern painted, etched or molded on a light guide. The extractor pattern may be determined from an edge-enhanced input pattern and modified iteratively to produce an edge-enhanced output pattern.

### CROSS-REFERENCE TO RELATED APPLICATIONS

This application is a continuation in part of U.S. patent application Ser. No. 11/267945, filed on 4 Nov. 2005, entitled “METHODS FOR MANIPULATING LIGHT EXTRACTION FROM A LIGHT GUIDE” and also claims the benefit of U.S. Provisional Patent Application 60/802482, filed 22 May 2006, entitled “HIGH CONTRAST EDGE-LIT SIGNS AND IMAGES,” the entire disclosures of which are hereby incorporated by reference herein.

### FIELD OF THE INVENTION

This application relates generally to methods for manipulating the extraction of light from a light guide, and relates more specifically to methods for determining the extractor element arrays and adjusting the spatial distribution of light extracted by these extractor elements from a light guide.

### BACKGROUND

Light guides are used in a wide variety of applications to transmit light from one location to another. Light guides having a variety of different geometries have been developed for different applications. For example, a light guide configuration that is particularly useful in display applications is a planar light guide. In a typical display configuration, a light source is positioned along an edge of a planar light guide, such as a sheet of glass or plastic that is configured to receive light generated by the light source. Light propagates through the light guide by total internal reflection. A particular light distribution can be output when light from the source propagates within the light guide and is extracted through the planar surface using patterning on the light guide to extract the light. The extracted light is optionally passed through subsequent optical components, such as diffusers, light recycling films, and/or spatial modulators.

Light is extracted from the planar surface of the light guide using one or more of a wide variety of extraction elements. Generally, the extraction elements comprise a feature that causes light to propagate out of the light guide instead of being totally internally reflected within the light guide. Extraction elements may comprise, for example, raised or recessed surface features such as protrusions or dimples, as well as localized material differences or other surface or volume perturbations in the light guide. Often the extraction elements are arranged to extract a substantially uniform light field from the light guide, which is particularly advantageous in the context of providing a uniform illumination field for a display surface. Because the extraction of light spatially changes the amount of light within the sheet, the luminance of the viewed display will be different than the pattern that is applied.

When light is extracted from a planar light guide, non-uniformities in the illumination of the light guide are manifested in a non-uniform illumination field extracted from the light guide. In the context of a planar light guide used to illuminate a display field, such non-uniformities are manifested as brightly illuminated regions and poorly illuminated regions of the display field. To achieve a uniform light distribution, the extraction elements can be spatially distributed such that more light is extracted from the light guide in poorly-illuminated regions, and less light is extracted from the light guide in well-illuminated regions.

The approach of increasing the density of extractor elements in regions that are “dim” and reducing the density of extractor elements in regions that are bright is easy for some simple patterns. However the process of adjusting the pattern to compensate for ‘dim’ and ‘bright’ portions of the viewed image becomes increasingly difficult as the average light extracted from the display is increased.

For other applications, a planar light guide having extractors can be used to display information. One such example comprises an “EXIT” signs. In another example, letters and numerals of a house or business address can be displayed. The extractors can be arranged to produce the desired light distribution, which in such examples forms letters, numbers, characters, etc.

In yet other applications, the planar light guide and extractors can be configured to produce an image. What are needed are methods for determining the extractor pattern to produce clear high contrasts images.

### SUMMARY

A method of defining an array of extractor elements that is configured to extract light from a light guide to produce a spatial light pattern across the light guide, the method comprising: receiving an input pattern; edge enhancement filtering said input pattern thereby producing an edge-enhanced pattern; and determining an array of extractor elements based on said edge-enhanced pattern.

A method of defining an array of extractor elements configured to extract light from a light guide, thereby producing a desired spatial light pattern E_{T} quantifying optical output at a plurality of locations across the light guide, the method comprising: calculating a smeared version of a first spatial light pattern produced by a first array of extractor elements, the first spatial light pattern quantifying optical output at the plurality of locations across the light guide; comparing the smeared version of the first spatial light pattern with the desired spatial light pattern; and determining a characteristic of a second array of extractor elements based on the comparison of the smeared version of the first spatial light pattern and the desired spatial light pattern such that the second array of extractor elements produces an edge enhanced version of the image produced by the first array of extractor elements.

A method of defining an array of extractor elements configured to extract light from a light guide, thereby producing a desired spatial light pattern E_{T} quantifying optical output at a plurality of locations across the light guide, the method comprising: calculating a smoothed version of a first spatial light pattern produced by a first array of extractor elements, the first spatial light pattern quantifying optical output at the plurality of locations across the light guide; comparing the smoothed version of the first spatial light pattern with the desired spatial light pattern; and determining a characteristic of a second array of extractor elements based on the comparison of the smoothed version of the first spatial light pattern and the desired spatial light pattern such that the second array of extractor elements produces an edge enhanced version of the image produced by the first array of extractor elements.

### BRIEF DESCRIPTION OF THE DRAWINGS

Exemplary embodiments of the methods, extraction element configurations, and results disclosed herein are illustrated in the accompanying schematic drawings, which are for illustrative purposes only.

FIG. 1 schematically illustrates the perspective view of a planar light guide with binary extractor pattern.

FIG. 2 schematically illustrates a wedge shaped light guide panel.

FIG. 3 schematically illustrates a partial hemispherical light guide panel.

FIG. 4 schematically illustrates a curved light guide panel.

FIG. 5 schematically illustrates a perspective view of a planar light guide with grayscale extractor pattern and a clear region without any extractors around the pattern.

FIG. 6 schematically illustrates an enlarged perspective view of a planar light guide with extractor pattern.

FIG. 7 schematically illustrates a sandwiched assembly with extractor elements illuminated from two sides.

FIG. 8 illustrates schematically extractors created using colored absorbing dyes.

FIG. 9 illustrates schematically extractors created using multi-layer color films.

FIG. 10 is a conceptual plot of available power within the light guide, extraction efficiency across the light guide, and power extracted from the light guide, all as a function of distance from a light source at one end of the light guide.

FIG. 11 illustrates a light guide panel with a binary extractor pattern matched to a desired output.

FIG. 12 indicates the simulated light output obtained by the binary extractor pattern of FIG. 11.

FIG. 13 is the measured light output from a fabricated prototype with a binary extractor pattern described in FIG. 11.

FIG. 14A is a flowchart showing an example process for obtaining an extractor pattern from an edge-enhanced input pattern. FIG. 14B is a flowchart showing an example process of modifying the extractor pattern.

FIG. 15 is a flowchart showing an example process for modifying an initial extractor pattern by smearing the spatial light pattern obtained from the initial extractor pattern.

FIG. 16 is a flow chart showing an example process for iteratively adjusting the extractor element array design to obtain a target spatial light distribution from a light guide.

FIG. 17 illustrates a light guide panel with a modified extractor pattern matched to a desired output.

FIG. 18 is the light output from the extractor pattern of FIG. 17 predicted by simulation.

FIG. 19 is the measured light output from a fabricated prototype using a modified extractor pattern of FIG. 17.

FIG. 20 shows a grayscale extractor pattern matched to a desired output.

FIG. 21 is the simulated light output from the extractor pattern of FIG. 20.

FIG. 22 shows a modified grayscale extractor pattern for a desired output.

FIG. 23 is the simulated light output from the extractor pattern of FIG. 22.

FIG. 24 shows the modified extractor pattern with the density scale going from 0 to 0.5.

FIG. 25 shows the modified extractor pattern with the density scale going from 0 to 1.

FIG. 26 shows the grayscale extractor pattern with the density scale going from 0 to 0.5.

FIG. 27 schematically illustrates an extractor element with a single rectangular scatterer.

FIG. 28 is the result of splitting the extractor element of FIG. 27 into a 2×2 array.

FIG. 29 is the extractor pattern based on extracting elements similar to FIG. 27.

FIG. 30 is the extractor pattern based on extracting elements similar to FIG. 28.

FIG. 31 illustrates a 300×300 target pattern obtained with a hybrid extractor pattern comprising a binary extractor pattern with grayscale extractor pattern near the edges.

FIG. 32 illustrates a 345×345 target pattern obtained with binary extractor pattern.

FIG. 33 illustrates a modified hybrid extractor pattern.

FIG. 34 shows the simulated light output from the modified hybrid extractor pattern of FIG. 33.

FIG. 35 conceptually depicts the application of an edge-lit display as a privacy filter.

### DETAILED DESCRIPTION OF CERTAIN PREFERRED EMBODIMENTS

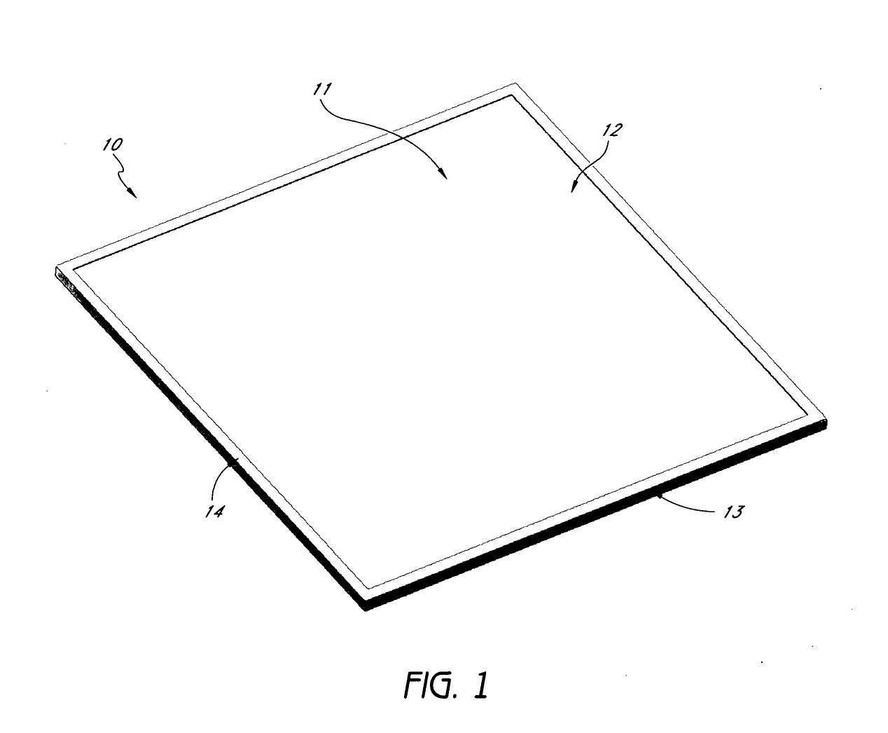

FIG. 1 schematically illustrates the perspective view of an example sign 10 comprising a planar light guide and an extractor pattern. The sign in FIG. 1 comprises a sheet 11 of optically transmissive material such as glass, plastic, PMMA or any other polymer can guide light. The sign 10 may be framed on all the four sides by an absorbing layer 12. The absorbing frame may be used to block light that might escape near the edges and be distracting or block ambient that could couple into the sign. The example optically transmissive sheet, illustrated in FIG. 1, comprises two planar surfaces and four edges. Three edges of the sign 10 include a reflecting surface 14. The reflecting surfaces 14 may be specular reflecting surfaces. The reflecting surfaces 14 may be formed by a reflecting coating or film. In some embodiments, the reflection coefficient of the reflecting surfaces 14 can be greater than 95%. A light source 13 is positioned along the fourth edge of the sign 10. The light source 13 may comprise of one or more fluorescent lamps, incandescent lamps, cold cathode fluorescent lamps, light emitting diodes or laser diodes. In certain embodiments, the light source 13 is configured to generate multi-chromatic light (for example, white light). In certain other embodiments, the light source 13 may generate substantially monochromatic light at one or more wavelengths. One example of such a light source is an array of red, green and blue light emitting diodes (an “RGB LED array”). In the example embodiment, the light source 13 may comprise strips of light emitting diodes (LEDs) positioned along at least a portion of the fourth edge. An extractor pattern is applied to a first planar surface of the optically transmissive sheet 11. In some embodiments, light from the light source guided within the sheet is output through a second planar surface of the sheet 11 directly opposite to the first planar surface. In other embodiments the extractor pattern can be applied to both the planar surfaces. In yet other embodiments, the extractor pattern can be applied to the same planar surface through which light is output. The extraction pattern may be binary or grayscale. In a binary extractor pattern, each pixel has two states: on or off. A binary extractor pattern for example may be formed by presence or absence of an extractor element. In contrast, each pixel of a grayscale extractor pattern may have a variety of states between on and off. The amount of light output by each extractor element of a grayscale extractor pattern may vary between a maximum and a minimum amount. This may be accomplished, for example, by varying the physical characteristics such as height, width or shape of the extractor elements of the grayscale extractor pattern.

Still referring to FIG. 1, the optically transmissive sheet 11 is configured to receive and propagate light generated by the light source 13. The reflecting surfaces 14 assist in reducing the amount of light that escapes from the edges. Systems for coupling light from the light source 13 into the sheet 11 can be used. For example, in an embodiment wherein the light source 13 comprises fluorescent or incandescent lamps, a reflector is positioned on the edge directly opposite the source. Other configurations are used in other embodiments.

In an example embodiment, the sheet 11 comprises a material that is substantially optically transmissive to one or more wavelengths generated by the light source 13. In example embodiments, the sheet 11 comprises a material having a higher index of refraction than other surrounding materials, such that light is guided within the sheet 11 by total internal reflection. The sheet 11 may have a variety of thicknesses. In some embodiments, the sheet 11 may comprise a film, which may be disposed on a substrate. The film may have extractors formed thereon or therein.

A plurality of extraction elements are applied to one or both surfaces of the sheet 11. The light from the source 13 propagating within the sheet 11 is directed out of the sheet 11 by the extraction elements. The display pattern viewed at the output of the sheet 11 is defined by the arrangement and distribution of the extraction elements. A reflecting (e.g. white) layer may be placed directly rearward the first planar surface to scatter light toward the output surface. The reflecting layer may be replaced by a specular reflecting layer (e.g. mirror or metalization) or any other reflector as well.

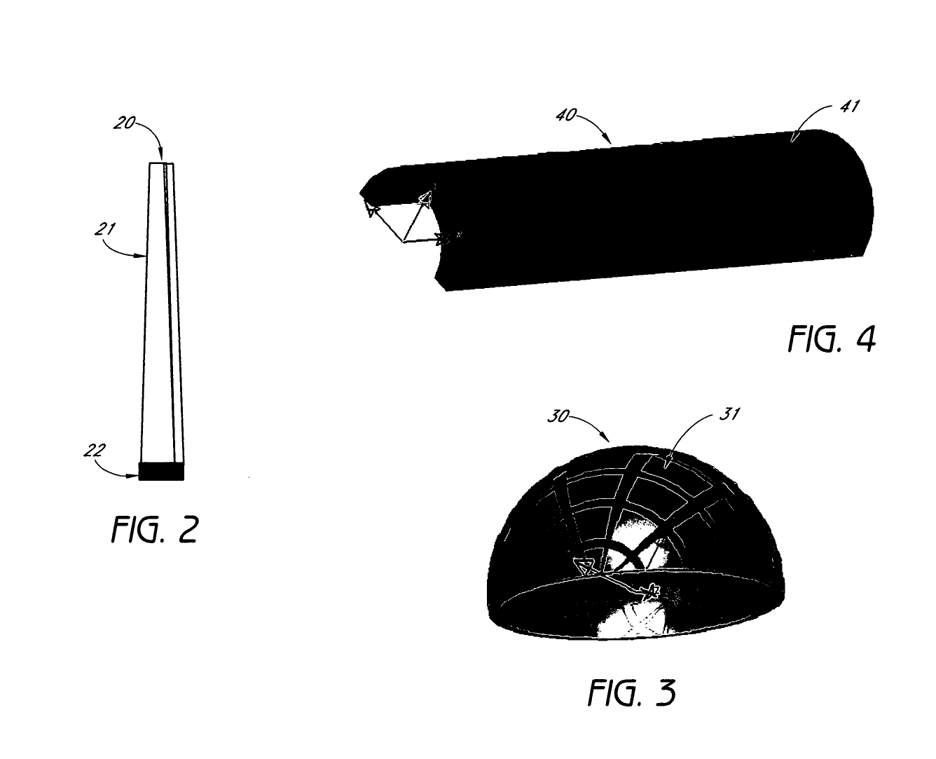

The exemplary light guide described above is a planar light guide. However other geometries can be used to form the light guide in other embodiments. For example, the light guide may be non-planar such as wedge-shaped, as shown in FIG. 2. The embodiment 20 in FIG. 2 has a wedge shaped light guide 21 with an extractor pattern applied to one surface. A light source 22 is disposed along one edge of the light guide 21 to edge illuminate the extractor pattern. In another embodiment the light guide may be hemispherical, as shown in FIG. 3. In the embodiment 30 shown in FIG. 3, the extractor pattern 31 may be applied to the outer curved surface of the hemispherical light guide. The light source may be disposed along the rim of the hemispherical light guide. Alternately, the light source may be disposed along the inner surface of the hemispherical light guide. In yet another embodiment the light guide may be cylindrical as shown in FIG. 4. In the embodiment 40 shown in FIG. 4, the extractor pattern 41 may be applied to the outer curved surface of the cylindrical light guide. The light source may be disposed across the length of the cylindrical light guide towards the inner surface. Alternately, the light source may be disposed along the inner surface of the cylindrical light guide.

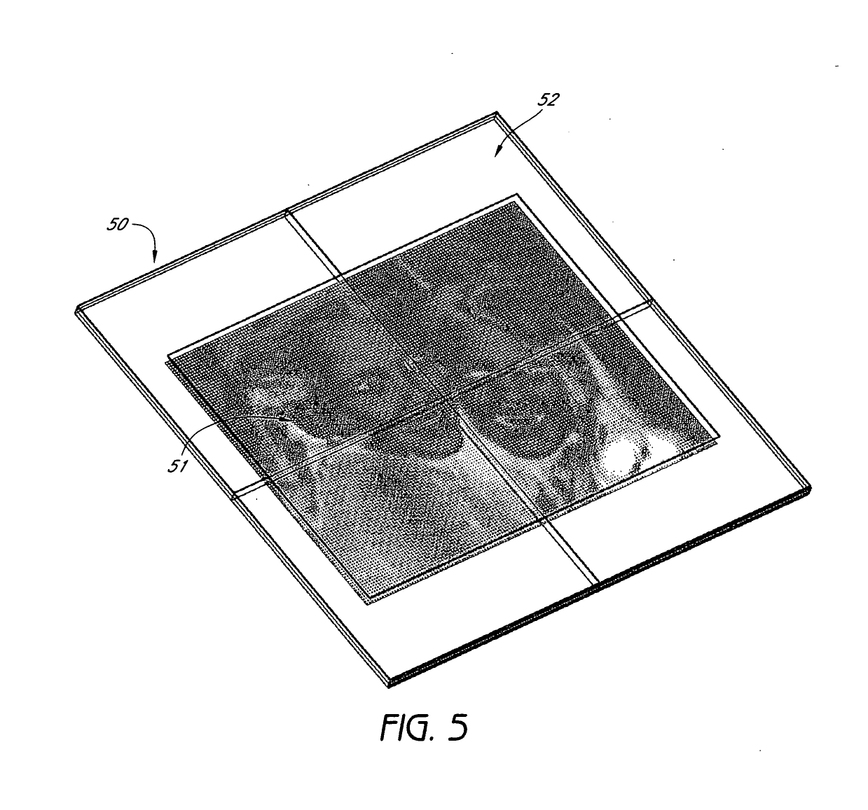

The exemplary sign 10 of FIG. 1 described above may be modified as shown in FIG. 5. The exemplary embodiment 50 of FIG. 5 may have a clear region 52 with no extraction elements placed around the region with extraction elements 51. The addition of the clear region 52 can provide the edge-lit sign the appearance of “floating in air” which may be valuable in certain decorative applications. A specular mirror or any other reflecting surface may be disposed behind the sign. The reflecting surface may improve the contrast ratio and the brightness of the sign without much detriment to the “floating in air” effect.

As used herein, the term “extraction element” is used broadly, and in addition to its ordinary meaning, it refers generally to a feature used to cause light to be coupled out of the light guide through one or more planar surfaces. For example, in one embodiment the extraction elements may comprise a region of increased surface roughness. In some embodiments, an ordered, random, or pseudo-random array of raised features (such as a pattern of protrusions or ridges) or recessed features (such as a pattern of dimples or grooves) function as extraction elements. In certain embodiments, localized material differences or other surface and/or volume perturbations function as extraction elements. In one example, the extraction elements comprise paint dots. In certain embodiments, the extraction elements are evenly distributed over a planar surface of the sheet light guide. However, in other embodiments the extraction elements are distributed non-uniformly, or are positioned on only a portion of a surface of the light guide. This provides a technique for spatially manipulating light extraction from a light guide. Furthermore, in certain embodiments one or more characteristics of one or more of the extraction elements is spatially modulated, thereby providing yet another parameter for spatially manipulating light extraction from a light guide. Examples of such characteristics include, but are not limited to, feature dimension (for example, height or lateral dimension) and feature density, although other characteristics are modified in other embodiments, depending on the type of extraction element used.

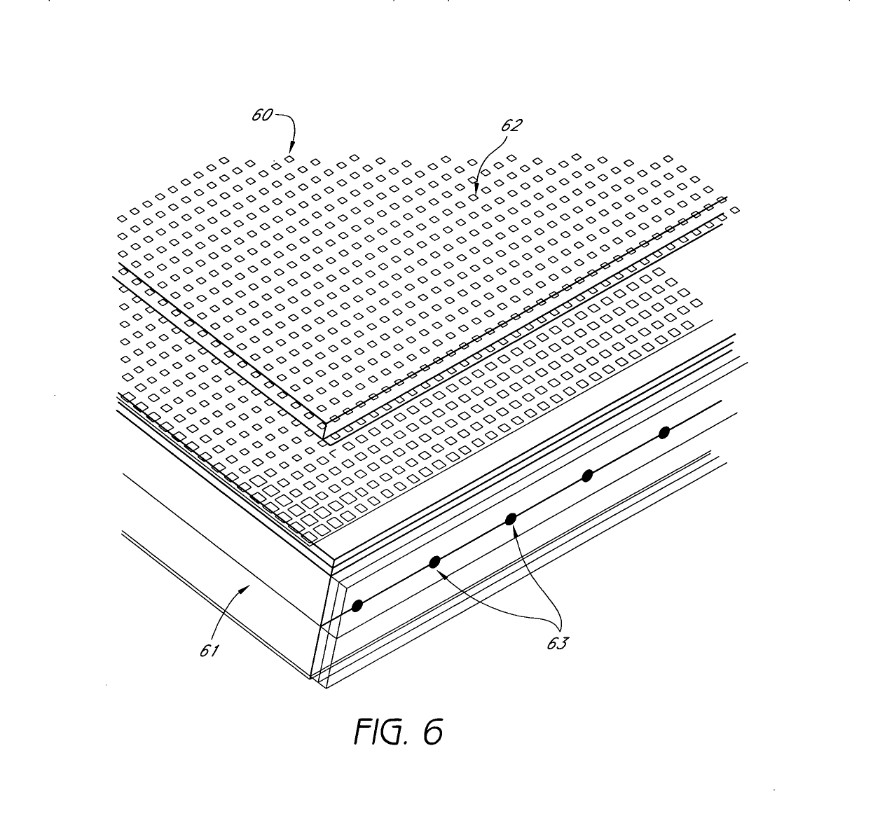

In an example embodiment 60, illustrated in FIG. 6, the extraction elements 62 are applied to a planar light guide sheet 61 using a painting technique, such as by applying paint dots to one or both surfaces of the planar light guide sheet 61. Other application techniques are used in other embodiments, such as laminating, layering, coating, depositing, molding, roughening, etching or carving. In some embodiments, the extractor pattern may be formed by laser etching. In some embodiments, laser etching comprises directing a laser beam into the light guide to write an extractor pattern. In some other embodiments the extractor pattern may be formed by molding techniques. The extraction elements are configured to refract, reflect, diffract, and/or scatter light propagating within the light guide 61. In some embodiments, a frame may be positioned along the extraction elements. The frame may be absorbing. Alternatively in some embodiments, the frame may be transparent as shown in FIG. 6. In the embodiment 60 illustrated in FIG. 6, the extraction elements 62 are illuminated by LEDs 63 disposed along one edge of the light guiding sheet 61. The LED may be configured to emit a single color. Alternatively, LEDs emitting in the red, green and blue wavelength range may be configured along the edge. The LEDs may be arranged in a linear manner. Alternate spatial arrangements of LEDs or other light sources are also possible.

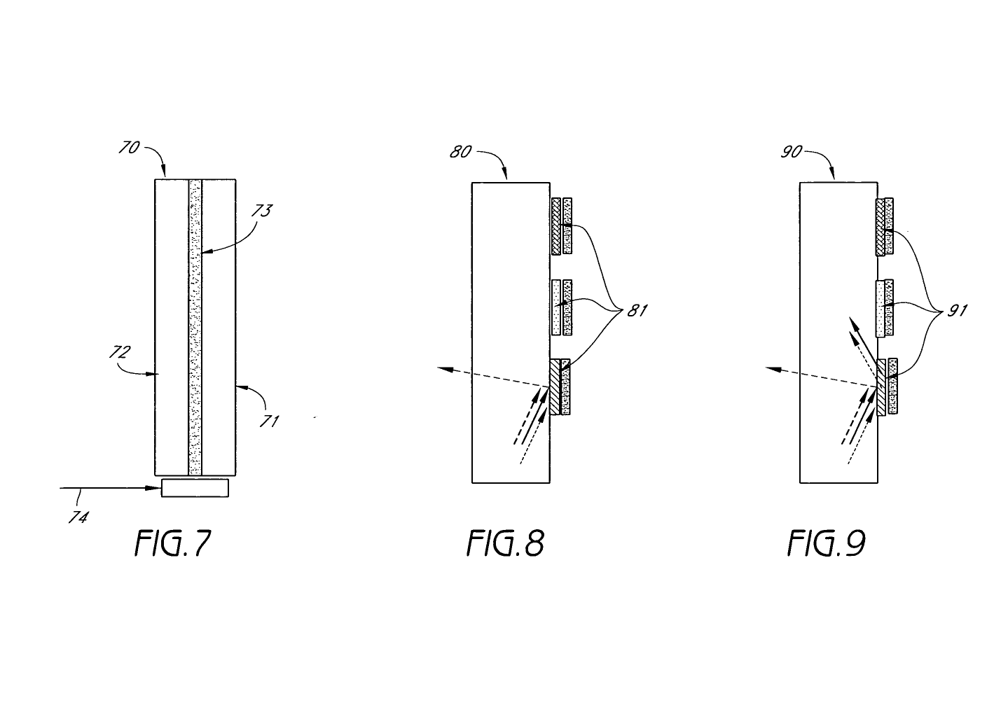

In certain other embodiments, the extractor material may only allow the light to be reflected. In such embodiments, applying the extractor pattern to one surface only allows the extracted light to be viewed from one side of the light guide. In such embodiments, laser etching may be used to etch the extractor pattern into the bulk of the thick light guiding material. This technique allows the display to be viewed from above and below the pattern. Alternately in other embodiments, the extractor pattern 73 may be etched on the surface of two light guides 71 and 72 that are then joined together to form a sandwiched display structure 70, for example, as shown in FIG. 7. A single source 74 may be used to edge illuminate the two light guides 71 and 72 simultaneously. In some other embodiments, two separate sources may be used to edge illuminate the two light guides.

A color edge-lit sign or display may be obtained by forming the extractor pattern using colored inks or paints. FIG. 8 illustrates an embodiment 80 with extractor elements 81 formed with color dyes. In certain embodiments, the extractor elements are formed using absorbing dyes, for example red, green and blue dyes. When the above described extractor elements are illuminated with multicolor light then the light corresponding to the color of the dye is reflected and the rest of the light is absorbed. For example, if the extractor elements formed with red dye is illuminated with red, blue and green light, then the extractor element will reflect red light and absorb the blue and green light.

A color edge-lit sign having extractor patterns formed with absorbing dyes may have reduced brightness due to absorption losses. In some embodiments therefore it might be desirable to form the extractor patterns using color films that will reflect the desired color out of the display and partially reflect the other colors into the light guide for reuse. FIG. 9 illustrates a light guide 90 that uses extractor patterns 91 formed with color reflecting films, for example red, blue and green film. One method to form such a color reflecting film is a layered structure such that a first color is reflected specularly and a second color is transmitted toward a scattering surface. The second color is then scattered and passes back through the structure into the light guide. When the extractor element with red film is illuminated by red, green and blue light, the red light is reflected at near normal angle out of the light guide while blue and green light are reflected through a larger angle into the light guide where they are reused to further illuminate other extractor elements. While certain example configurations of the extraction elements are described here, the methods for manipulating light extraction from a light guide disclosed herein are not limited to certain types or configurations of extraction elements, and thus these methods are equally applicable to other types of extraction elements not disclosed herein, including future developed extraction elements.

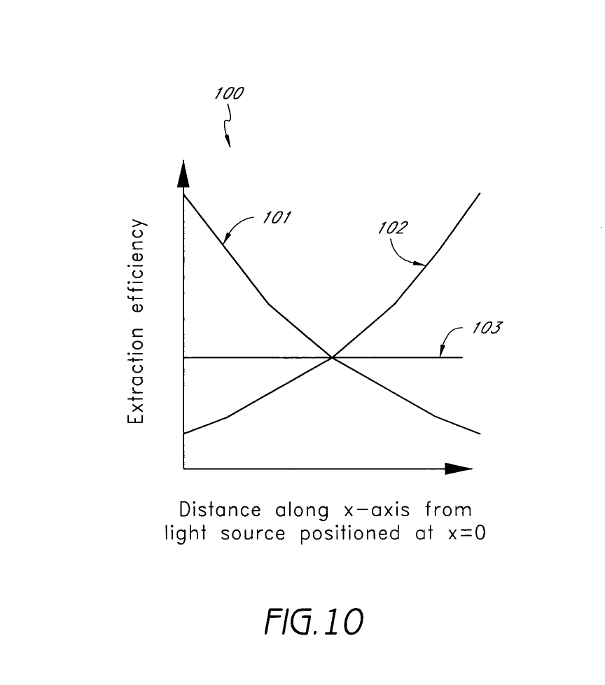

The arrangement of the extractor elements may vary with different designs. For example, FIG. 10 is a conceptual plot of available power within the light guide (curve 101), extraction efficiency (curve 102), and power extracted from the light guide (curve 103), all as a function of distance from the light source. FIG. 10 presents a case wherein the power extracted from the light guide is independent of the distance from the light source. FIG. 10 indicates that more power is available within the light guide in a region closer to the light source, but that the extraction elements are configured to extract light from the light guide relatively inefficiently in this region. On the other hand, less power is available within the light guide in a region further from the light source, but the extraction elements are configured to extract light from the light guide relatively efficiently in this region. This combined result is a level of power extracted from the light guide that is independent of the distance from the light source. There are several different techniques to change the efficiency of the extraction elements. One method is to vary the size of the extraction element to provide desired extraction efficiency. Another method is to vary the density of extraction elements according to the desired extraction efficiency.

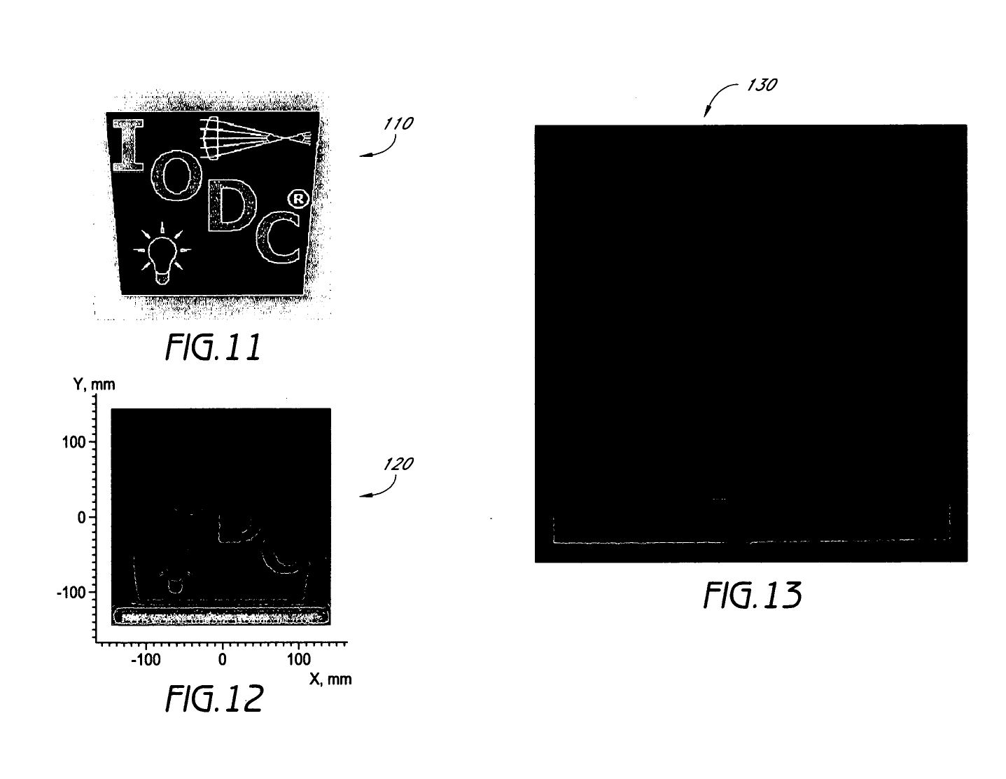

The embodiment illustrated in FIG. 11 is a binary extractor pattern. The binary extractor pattern is matched to a desired output. FIG. 12 shows the simulated output when the binary extractor pattern is applied to a planar light guide and edge lit by a light source. In certain embodiments, the binary extractor pattern when edge lit produces an output such that the light output varies with the distance from the light source, for example, as shown in FIG. 12. It is observed that the region near the bottom of the image produces a much higher luminance than the regions near the top of the image. FIG. 13 is a prototype fabricated with the binary extractor pattern of FIG. 11. Like the simulation results in FIG. 12, FIG. 13 indicates that areas farther away from the edge-light source are less bright than areas nearer the edge-light source.

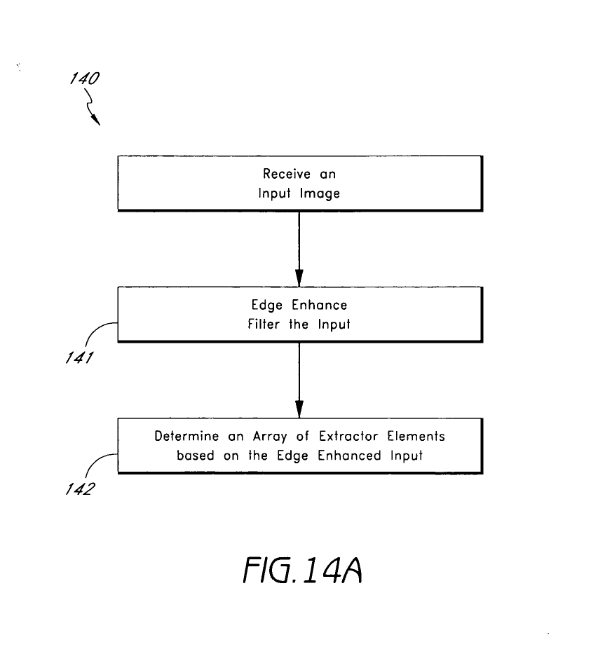

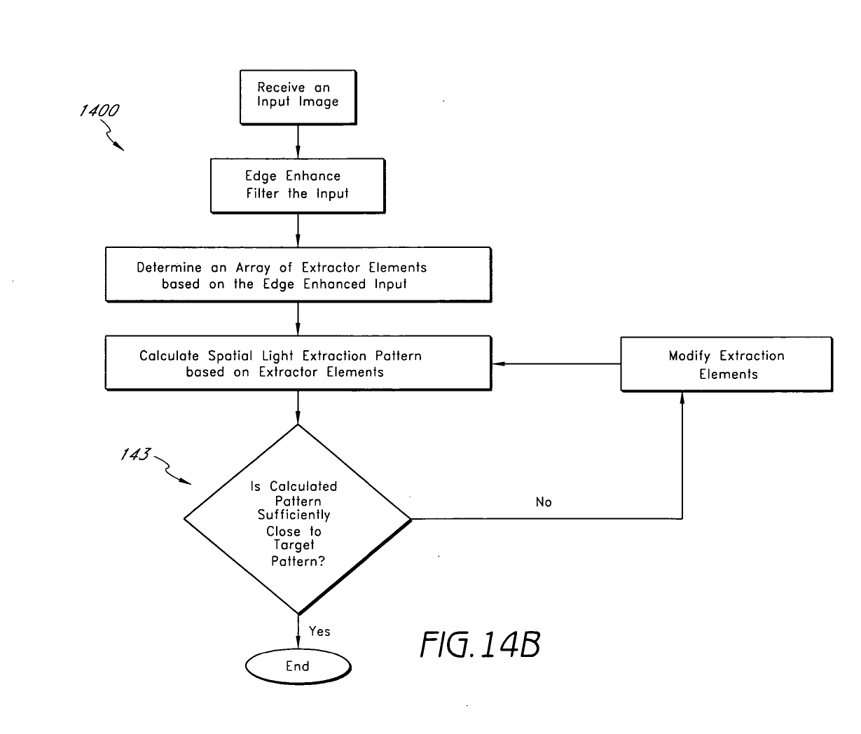

FIG. 14A shows a method to obtain an extractor pattern that can display images that are sharp, have increased resolution and contrast. In step 141 of the flow chart 140, an input pattern is edge enhanced filtered. The input pattern may be images, photographs, graphics, text, characters, numbers, letters etc. Edge enhancement filtering of the input pattern may be achieved by high pass filtering. In some embodiments, edge enhancement filtering may be achieved by nonlinearly modifying the input pattern, for example by increasing the heights of the peaks and decreasing the depth of the valleys. Other edge enhancement techniques may also be used. In step 142, the extractor pattern is obtained based on the edge enhanced input. The spatial light pattern obtained at the output of the extractor pattern determined by the above technique will have greater contrast than the spatial light pattern obtained from an extractor pattern that is based on the non-edge enhanced input pattern.

The extractor pattern obtained in step 142 can be further modified to improve the sharpness, resolution and contrast ratio of the image displayed by the extractor pattern. One method of modifying the extractor pattern is to compare the calculated spatial light pattern formed by the extractor pattern to the desired spatial light pattern as shown in step 143 of FIG. 14B. The characteristics of the extractor elements are modified so that after a number of iterations the calculated spatial light pattern output by the array of extractor elements is sufficiently close to the desired spatial light pattern.

Another method to further improve the sharpness, resolution and contrast ratio is by ‘smearing’ or smoothing the spatial light pattern output by the initial array of extractor elements. The initial array of extractor elements can be determined from an input pattern that is either edge enhanced filtered or not edge enhanced filtered. The spatial light pattern produced by the initial array of extractor elements is calculated, for example, by a ray tracing method. The ray tracing method can produce high frequency noise along with the image pattern. Increasing the number of rays can reduce the total noise content in the spatial light pattern. Repeating simulation runs and averaging can also reduce the total noise. In various embodiments, the spatial light pattern is smeared or smoothed to filter out higher frequency content in an image as opposed to filtering out only the high frequency noise. For example, a wide variety of photographs or grayscale images comprise image content having substantial high frequency components. These images generally exhibit high resolution. Smearing or smoothing such photographs or grayscale images reduces high frequency image content thereby blurring the photograph or image.

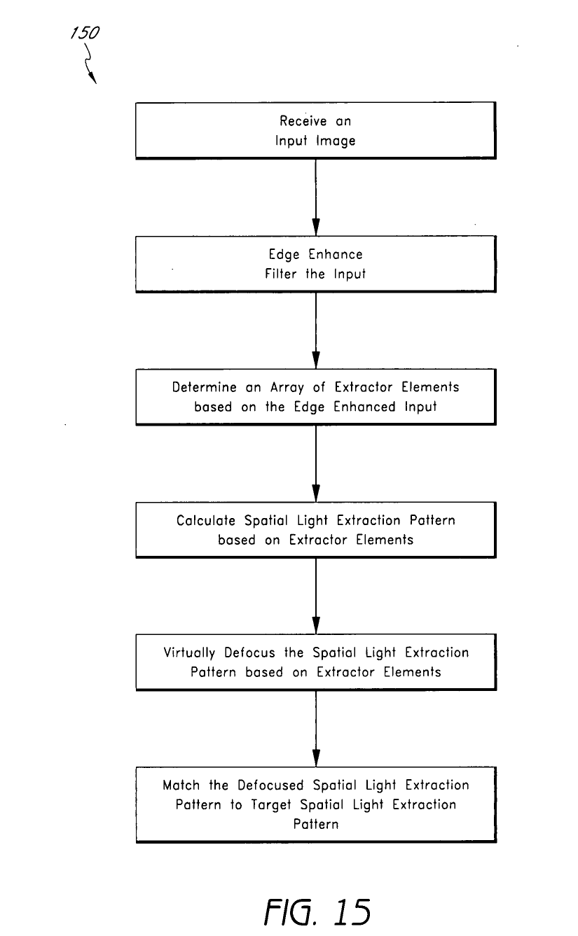

In various embodiments, the extractor elements are modified to increase the correspondence between the smeared spatial light pattern output by the modified array of extractor elements and the desired image. This process results in increasing the density of extractors around the edges and local density peaks of the extractor pattern and edge enhancing the output spatial light pattern produced by the modified extractor pattern. If the smeared or smoothed version of the output spatial light pattern matches the desired spatial light pattern then the un-smeared spatial light pattern produced by the modified extractor pattern will be a better match to the desired spatial light pattern. This process is illustrated in the flow chart of FIG. 15. The amount of virtual defocus selected may depend on the size of the extractor elements and the desired amount of edge enhancement.

A way to smear or smooth the output spatial light pattern is by virtual defocusing. One method to accomplish virtual defocusing is to collect the light rays exiting the output surface of the light guide through the initial array of extractor elements and use position and angles to compute the light distribution at a different surface a distance away from the array of extractor elements.

In other embodiments, the defocused image can be obtained at the image plane of a lens system that is used to image the array of extractor elements. The virtually defocused spatial light pattern may be a blurred version of the desired spatial light pattern.

Some spherical aberration can be present if all angles of rays are included in the light that is defocused. Spherical aberration may cause some defocusing. Limiting the cone angle of the rays that are defocused can reduce smearing or smoothing caused by spherical aberration. A ±30 degree cone may be sufficient to estimate the defocused spatial light pattern, however smaller and larger cone angles may be used. In certain embodiments, wherein the spherical aberration is sufficiently small and minimal smearing of the light is desired, the defocus distance back to the extractor surface is given by the ratio of the thickness of the light guide to the index of refraction of the light guide. Other defocus distance values can be used.

Another method to ‘smear’ or smooth the spatial light pattern output from the extractor pattern is to low pass filter the output spatial light pattern. A combination of low pass filtering and defocusing may be used to obtain the ‘smeared’ or smoothed version of the spatial light pattern. The shape and cut-off frequency of the low pass filter is such that the high frequency content of the image is filtered (as opposed to only filtering out high frequency noise) thereby resulting in a blurred image. Other methods to smear the spatial light pattern such as undersampling may be used as well. The sampling frequency may be chosen so as to filter out the high frequency components of the image thereby blurring the image.

Generally an iterative approach may be used to hone in on the solution. Iterative techniques can be used to modify the extractor pattern such that the output spatial light pattern may closely replicate the desired spatial light pattern. In certain embodiments, the initial array of extractor elements based on edge enhanced filtering the input pattern may be modified iteratively as illustrated in FIG. 16. In FIG. 16, in step 161 the spatial light pattern output by the extractor array is calculated. The output spatial light pattern is ‘smeared’ or virtually defocused in step 162 by using the techniques described above. The smeared version of the spatial light pattern is compared to the desired spatial light pattern in step 163. The characteristics of the extractor elements are adjusted in step 164 such that the smeared image more closely matches the desired image. Steps 161-164 are repeated until the smeared image is sufficiently close to the target image.

In some embodiments, the initial array of extractor pattern may be based on a non-edge enhanced input pattern.

In some embodiments, such an iterative process is used to produce a uniform spatial light pattern, while in other embodiments, such a feedback process is used to produce a spatial light pattern with a predefined, non-uniform spatial variation (such as an image). In either case, a target spatial light pattern may be used. As discussed herein this target spatial light pattern may also be modified for example by filtering such as edge enhancement filtering. Also, a spatial light pattern is estimated, for example, by using a computer simulation of the operation of a configuration of extraction elements. In other embodiments, the spatial light pattern is estimated by measuring a spatial light pattern generated by a prototype. Based on the spatial light extraction pattern determined by simulation, one or more characteristics of the extraction elements are iteratively modified such that, after a certain number of iterations, the actual light extraction pattern produced by the modified extraction elements more closely approximates the target light extraction pattern than the original light extraction pattern evaluated. Generally, the iterative adjustment process involves reducing extraction efficiency in regions where the amount of light extracted from the light guide is to be reduced, and increasing extraction efficiency in regions where the amount of light extracted from the light guide is to be increased.

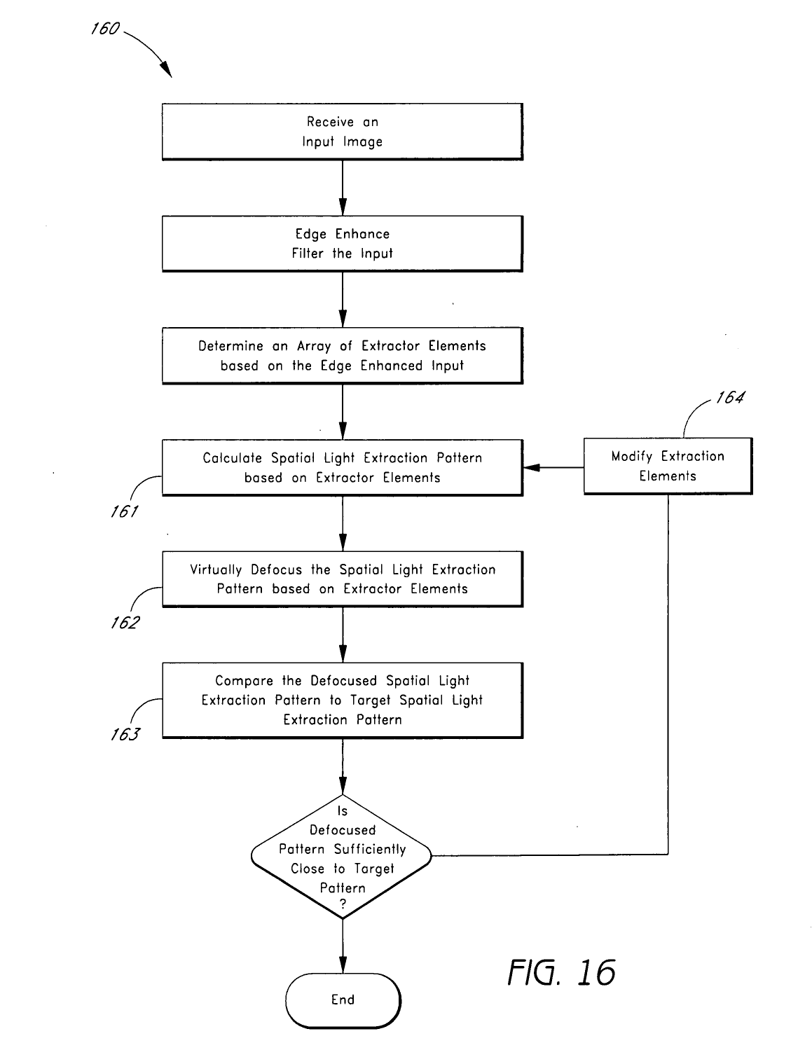

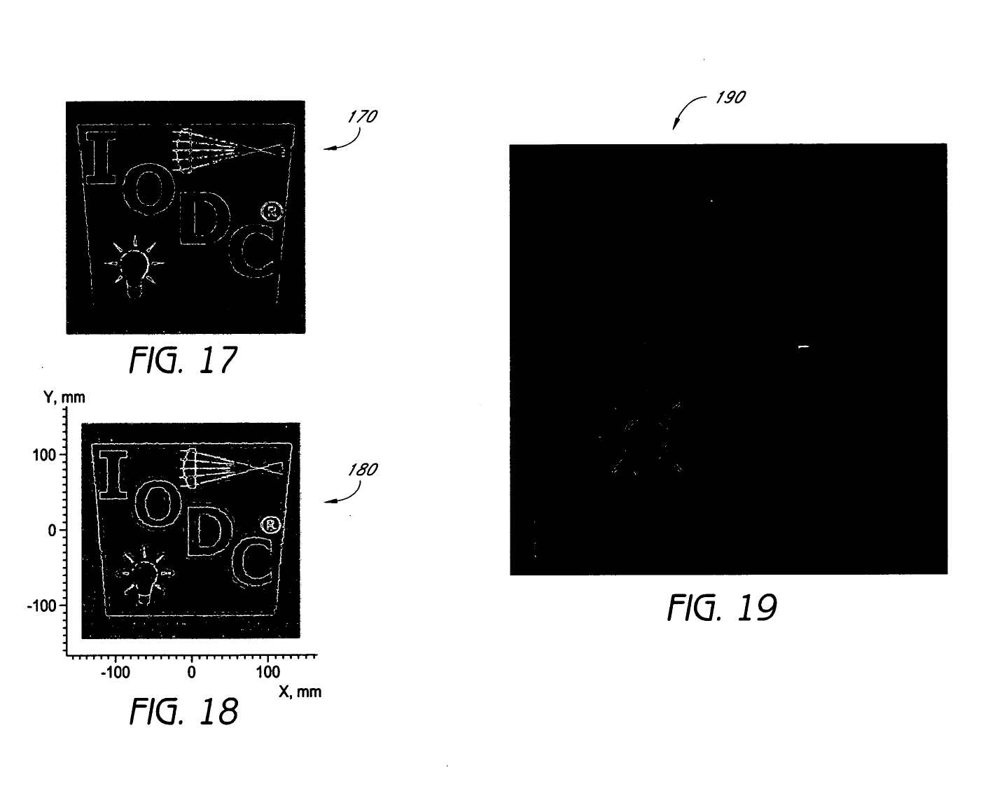

FIG. 17 indicates a modified version of the binary extractor pattern of FIG. 11 obtained by the method described above. The extraction pattern when edge-lit may produce an output spatial light pattern that does vary with the distance from the light source. FIG. 18, shows the simulated output of the extractor pattern of FIG. 17 that is edge-lit. FIG. 19 shows a prototype fabricated with the modified extractor pattern of FIG. 17. FIG. 19 shows that the areas both close to and far from the light source have more uniform illumination levels when edge-lit by a source. The output from the prototype has approximately the same brightness level across the prototype, with some increase near the transition between lit and unlit areas. Edge enhanced filtering can therefore advantageously be used to produce an improved output. This improved output may have sharper features and higher contrast.

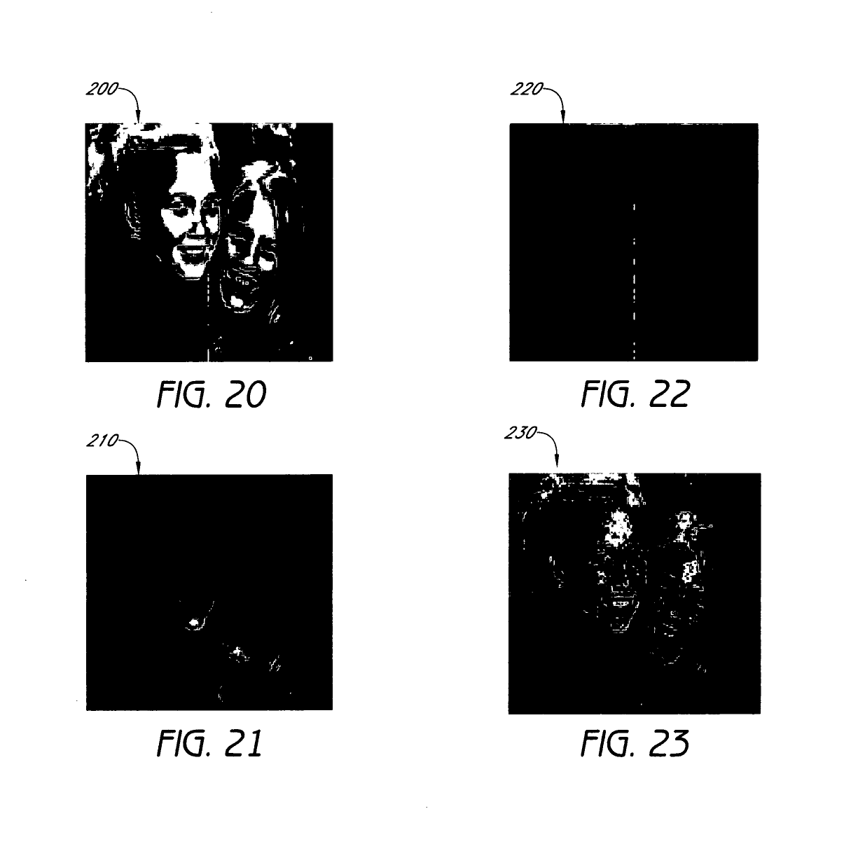

Similar to the binary extraction pattern, grayscale extraction pattern also can produce images with areas closer to the light source being brighter than areas away from the light source. The embodiment illustrated in FIG. 20 is a grayscale extractor pattern that is matched to a desired output. FIG. 21 shows the simulated output when the grayscale extractor pattern is edge lit. FIG. 21 shows an output with bright and dim regions. Areas closer to the light source in the simulated output are brighter and areas farther from the light source are generally dimmer. For example the chins in FIG. 21 have higher luminance than the hair.

In FIG. 22, the grayscale extractor pattern of FIG. 20 is modified by the techniques described above. The modified grayscale extraction pattern when edge-lit produces an output that has approximately the same illumination in all areas as observed from FIG. 23 which indicates a simulated output of the modified grayscale extractor pattern of FIG. 22 that is edge-lit. It is observed that the chins and hair have almost equal luminance in FIG. 23 as compared to FIG. 22.

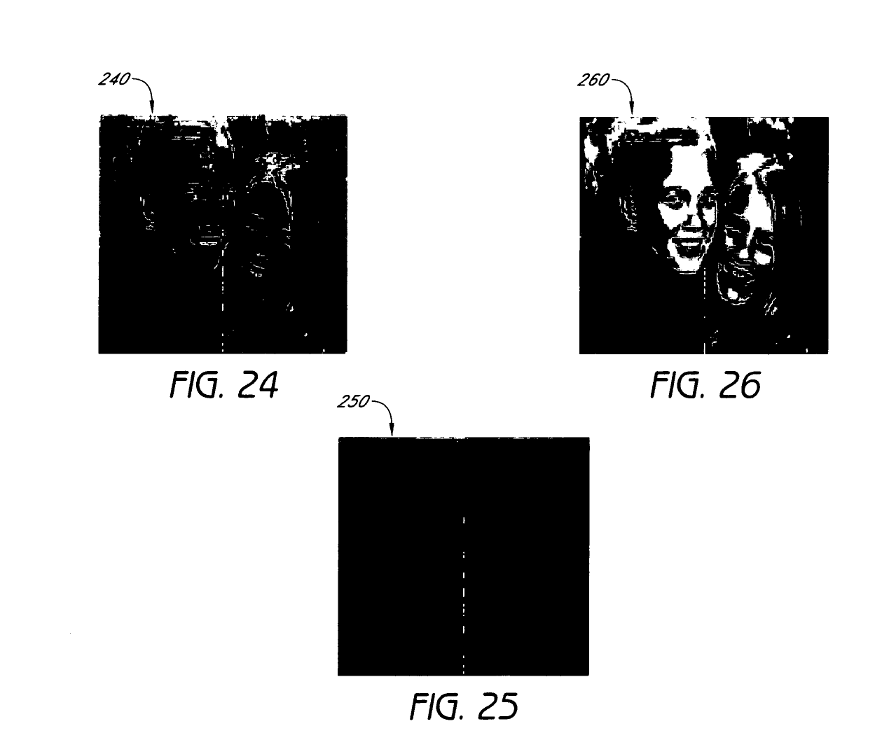

FIG. 24 shows the edge-enhanced filtered grey scale extractor pattern on a density scale from 0 to 0.5. FIG. 25 shows the same edge enhanced filtered grey scale extractor pattern on a density scale from 0 to 1. FIG. 26 shows the non-edge enhanced filtered grayscale extractor pattern on a density scale from 0 to 1. It is observed that the edge enhanced grayscale extractor pattern of FIG. 25 is darker (or less bright) than the non-edge enhanced grayscale extractor pattern of FIG. 26. This is because the edge enhanced grayscale extractor pattern has lower average density than the non-edge enhanced grayscale extractor pattern as a result of normalization. The output images produced by the edge enhanced grayscale extractor pattern are sharper. Accordingly, in certain embodiments, the input pattern or the target pattern can be preprocessed with a standard edge filter to reduce the “washed-out” effect.

For some applications it may be advantageous to diminish substantially the appearance of individual extraction elements in the spatial light pattern produced by an array of extraction elements. Accordingly, in some embodiments an optional diffuser is positioned over or forward of the light guide, such that light coupled from the extraction elements passes through the diffuser. This diffuser may comprise a planar diffuser or a diffusing sheet in some embodiments. The diffuser is configured to diffuse light. This diffusing effect may at least partially reduce the appearance of the light extractors in the illumination field extracted from the light guide. For example, in certain embodiments the diffuser comprises surface or volume features that symmetrically or asymmetrically scatter light passing there through. In such embodiments, the scattering may be substantially random from location to location across the diffuser. In some embodiments, the diffuser may be an optically transmissive element having a surface feature variation capable of randomly redirecting light in a wide range of angles, such as up to ±90° with respect to the incident angle. In some other embodiments, the diffuser may be configured to scatter over lower angles to reduce smearing the distribution.

In embodiments that do not include a diffuser, a higher resolution extractor pattern may be used to reduce the appearance of individual extractors. Other methods to reduce/minimize visual artifacts of the discrete extractors such as half-toning technique may be used. In certain embodiments, continuous or non-discrete extractor patterns (for example, using paints of different thickness) may be used to diminish the appearance of the individual extractor elements.

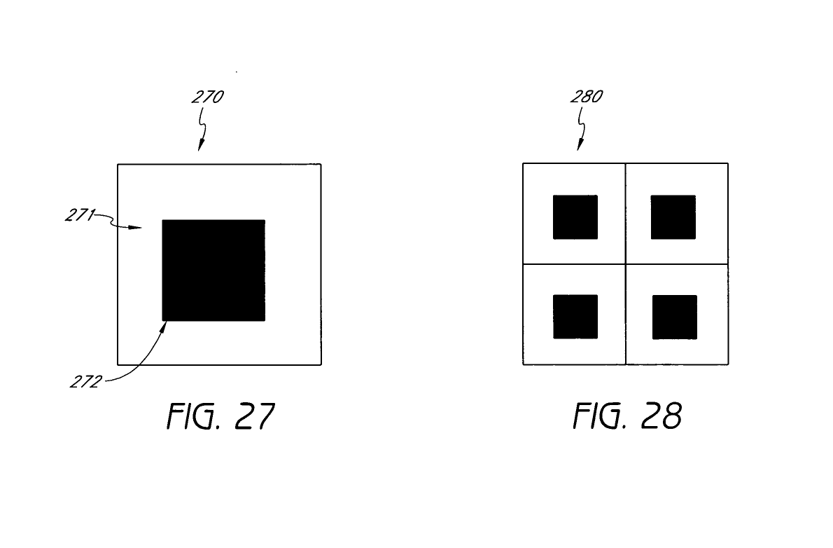

In certain embodiments, as shown for example in FIG. 27, the extractor element or pixel 270 may comprise a scattering center 272 bound by a clear region 271. The size of the scattering center 272 provides an estimate of the percentage density of the extractor element 270. The scattering center 272 may have variety of geometrical shapes such as rectangle, square, circle, oval or any other shape. The scattering center 272 may be flat and in the same plane as the clear region 271. Alternatively the scattering center 272 may be raised above or dimpled below the clear region 271. In some embodiments, the scattering center 272 may be situated off-center with respect to the clear region 271. The density of each extractor element in an array of extraction elements may be controlled by varying the size of the scattering center 272. The density of the extraction elements provides an estimate of the efficiency of the light coupled out of the light guide by the extractor element.

In some other embodiments, the single extractor element may be split into multiple extractor elements as shown for example in FIG. 28. In FIG. 28, the extractor element 270 of FIG. 27 is split into a 2×2 array of smaller extraction elements 280. The density of the 2×2 array of extraction elements 280 is the same as the original extraction element 270. However, the resolution of the display image produced by the extraction element 280 of FIG. 28 is twice the resolution of the display image produced by the extraction element 270 of FIG. 27. The process of dividing an original extractor element multiple times can be repeated to obtain images with higher resolution.

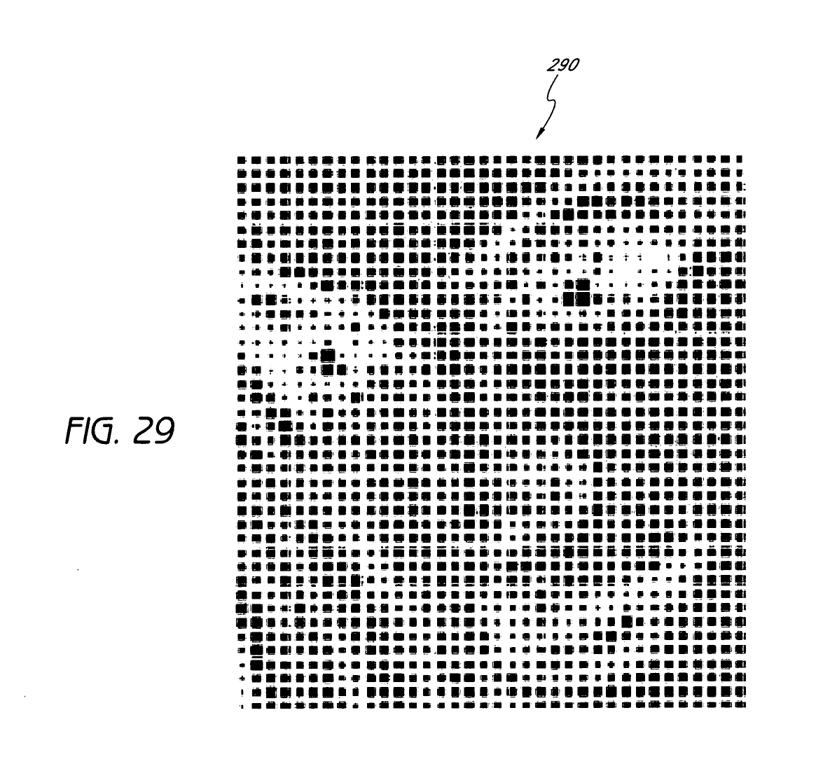

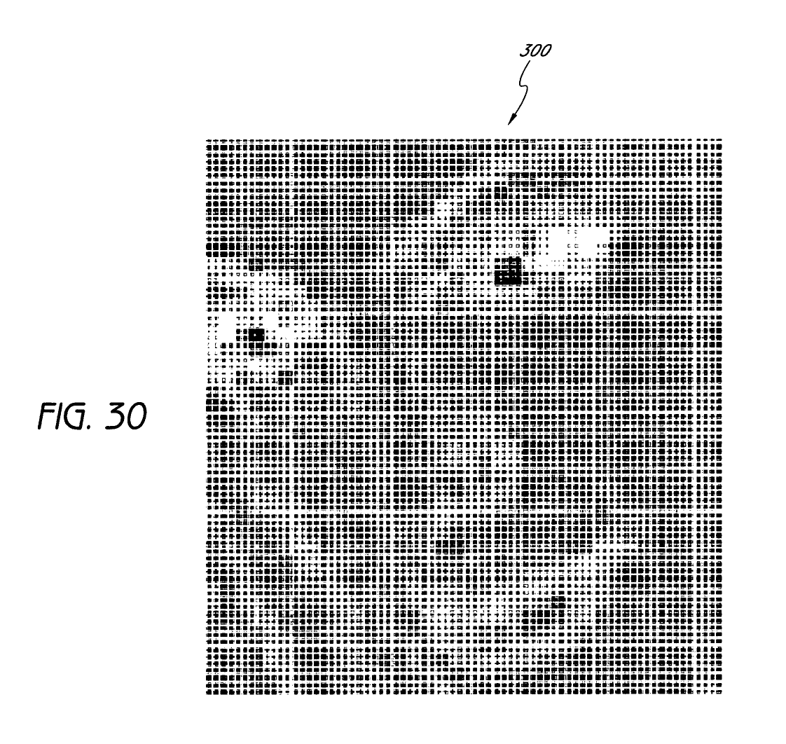

Image produced by an array of extraction elements with lower resolution may have a “grainy” appearance and the individual extractors may be visible. FIG. 29 for example shows an array of extraction elements similar to the extractor element in FIG. 27. Increasing the resolution two fold by extractor element division produces a smoother image and the appearance of individual extractors is reduced. FIG. 30 for example shows an array of extraction elements similar to the extractor element in FIG. 28. The extractor pattern depicted in FIGS. 29 and 30 have nominally the same average brightness but the extractor pattern of FIG. 30 has two times higher resolution than the extractor pattern of FIG. 29.

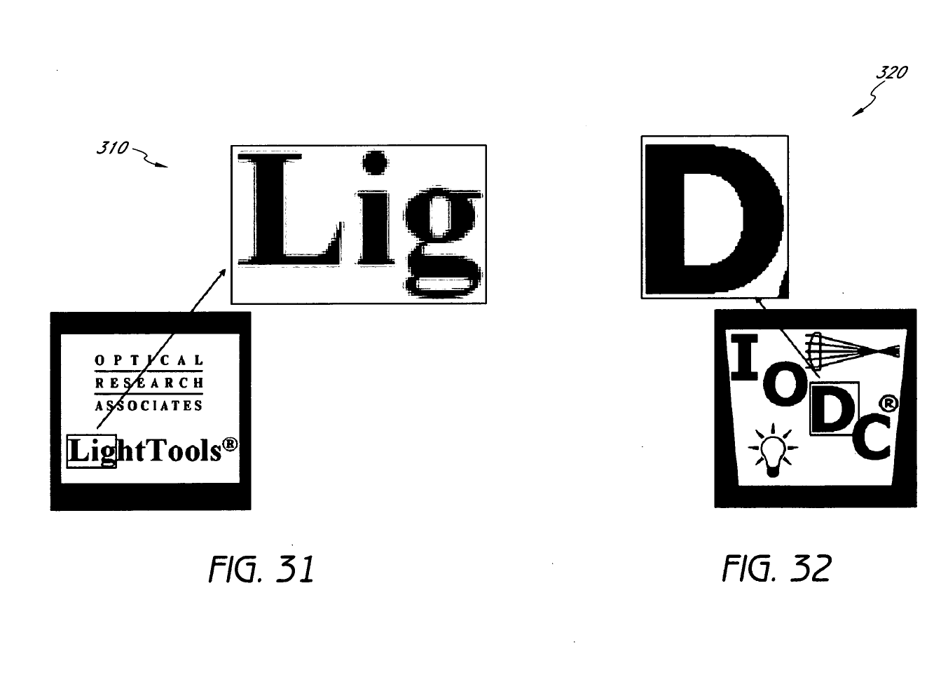

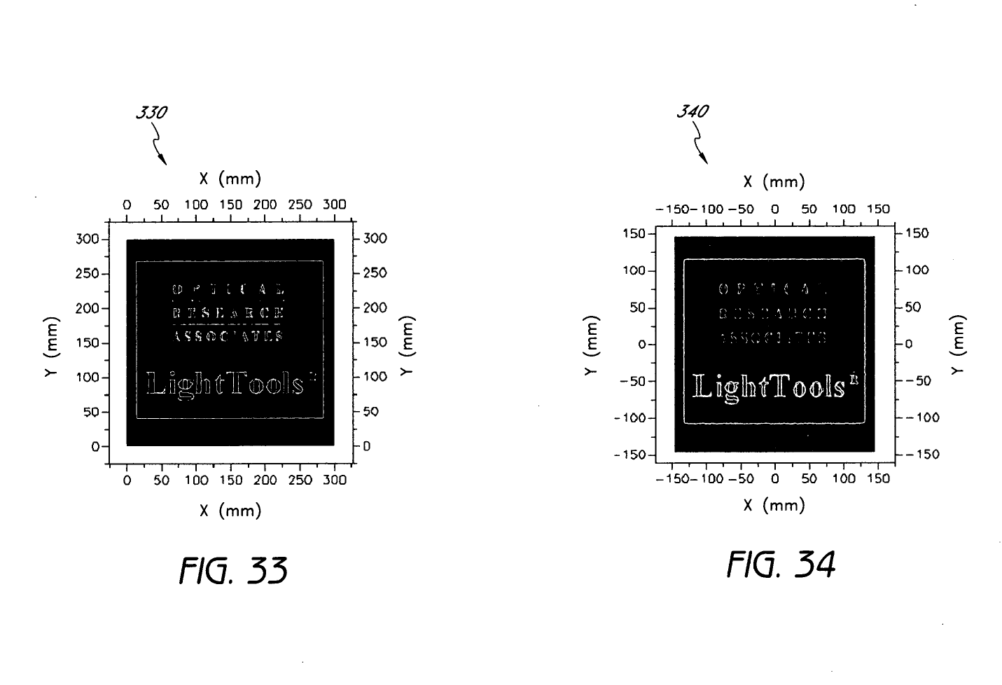

In certain embodiments, a hybrid extractor pattern may be formed by positioning grayscale extractor pattern near the edges of a binary extractor pattern. The hybrid extractor pattern may provide effectively higher resolution than a purely binary extractor pattern. For example, FIG. 32 shows a binary extractor pattern with a 345×345 pixel resolution. It is observed that the edges of the target pattern are blurred when enlarged. However, by placing grayscale extractor elements near the edges of the binary pattern a 300×300 resolution pattern provides a better image. Using grayscale results in diminished edge pixelation of the target pattern for example as shown in FIG. 31. The edge enhancing techniques described above to improve the contrast of the output of binary and grayscale extractor patterns may be applied to hybrid extractor pattern as well. FIG. 33 shows a hybrid extractor pattern based on an edge enhanced image using grayscale near the edges. FIG. 34 shows the simulated output when the hybrid extractor pattern derived from an edge enhanced image is edge-lit. It is observed that the spatial light pattern obtained from the hybrid extractor pattern of FIG. 33 has high contrast.

Examples of how the iterative process may be implemented are provided below. See also, e.g., U.S. patent application Ser. No. 11/267945, filed on 4 Nov. 2005, entitled “METHODS FOR MANIPULATING LIGHT EXTRACTION FROM A LIGHT GUIDE,” the entire disclosure of which is hereby incorporated by reference herein.

A characteristic of an extraction element at an arbitrary position (x, y) on the surface of the light guide is generally referred to herein as T(x, y). Example characteristics of an extraction element include, but are not limited to, the shape of an extraction element, the size of an extraction element, the spacing between extraction elements, the extraction efficiency of an extraction element and/or another property that affects how the extraction element couples light from the light guide. For example, in an embodiment wherein the extraction elements comprise regions of the light guide coated with a paint that alters the propagation of light within the light guide, the characteristic T(x, y) represents the portion of an area centered at (x, y) that is coated with the paint. Thus, in an embodiment wherein identical extraction elements are uniformly spaced over the entire surface of the light guide, T(x, y) is constant for all (x, y).

Optionally, the function T(x, y) is normalized, such that T(x, y)=1 for an extraction element having the maximum extraction efficiency for a given extraction element characteristic. For example, in an embodiment wherein the extraction elements comprise regions of the light guide coated with a paint that alters the propagation of light within the light guide, the normalized characteristic T(x, y)=1 for an area centered at (x, y) that is completely covered with paint.

In an example embodiment, the target spatial light pattern, also referred to as the “output distribution” pattern, is defined by target illuminance or luminance values at various points over the surface of the light guide, although other measures of light output are used in other embodiments. The function E(x, y) generally represents the illuminance for an area centered at position (x, y) in a spatial light pattern. E_{T}(x, y) represents the illuminance for an area centered at position (x, y) in a target spatial light pattern. For example, in an embodiment wherein light is to be uniformly extracted across the surface of the light guide, E_{T}(x, y) is constant for all (x, y). The illuminance at a given point E(x, y) is correlated with the extraction element characteristic T(x, y) at that point. Thus, in an example embodiment, the illuminance at a given point E(x, y) is adjusted by manipulating the characteristic T(x, y) at that point.

In certain modified embodiments, an imaging system is used to image the output of the light guide. Thus, in such embodiments, the illuminance E(x, y) is mapped to an imaged spatial light pattern with a corresponding distribution E′(x, y), which is then used to modify the characteristic T(x, y) of the extraction elements.

The following describes an example process for iteratively adjusting the extraction element characteristic T(x, y) to generate a spatial light pattern that estimates the target spatial light pattern, as defined by E_{T}(x, y). In this example, the target spatial light pattern is an image, for example, a portrait, a landscape or a graphic. This example iterative feedback process is initiated by modeling an initial array of identical extraction elements that are based on the initial input pattern. The initial input pattern may be edge enhanced filtered. The illuminance of the resulting initial spatial light pattern E₀(x, y) is modeled using a ray tracing technique to produce a spatial illuminance distribution. Optionally the ray tracing technique may be used to determine an in focus for example at the extractor pattern or defocused image. The characteristics of the extraction elements are then adjusted to produce a first iteration field of extraction elements T₁(x, y), where

$${T}_{1} ( x , y ) = {κ}_{0 \\} {T}_{0} ( x , y ) {( \frac{{E}_{T} ( x , y )}{{E}_{0} ( x , y )} )}^{α} , \\ where$$

$${κ}_{0} = \frac{max ( {T}_{0} ( x , y ) )}{max ( {T}_{0} ( x , y ) {( \frac{{E}_{T} ( x , y )}{{E}_{0} ( x , y )} )}^{α} )} .$$

As used herein, α is a damping coefficient that is included to attenuate the destabilizing affects of noise and to improve convergence to E_{T}(x, y). In an example embodiment, α≦1. The scaling constant κ₀ is included to optionally set the maximum value of T₁(x, y) to be substantially equal to the maximum value of T₀(x, y), which may help to increase the efficiency of the system. The first iteration field of extraction elements, defined by T₁(x, y), includes higher density of extraction elements at the edges and has lower average density of extractor elements. The resulting light extraction pattern associated with T₁(x, y), represented by E₁(x, y) has sharper edges as compared to the initial spatial light pattern E₀(x, y). The resulting light extraction pattern may alternately be edge enhanced filtered or smeared version of the initial spatial light pattern E₀(x, y).

The process of calculating a new extraction element field Tᵢ(x, y) based on the previous extraction element field Tᵢ₋₁(x, y) and the ratio of the target light extraction pattern E_{T}(x, y) to the previous light extraction pattern Eᵢ₋₁(x, y) may be repeated. The general expression for calculating the ith extraction element field Tᵢ(x, y) is

$${T}_{i} ( x , y ) = {κ}_{i - 1 \\} {T}_{i - 1} ( x , y ) {( \frac{{E}_{T} ( x , y )}{{E}_{i - 1} ( x , y )} )}^{α} , \\ where$$

$${κ}_{i - 1} = \frac{max ( {T}_{i - 1} ( x , y ) )}{max ( {T}_{i - 1} ( x , y ) {( \frac{{E}_{T} ( x , y )}{{E}_{i - 1} ( x , y )} )}^{α} )} .$$

The scaling constant κ may be included to possibly maintain the efficiency of the system. In particular, this definition of κ preserves high light extraction efficiency in regions of the light guide with low optical energy, as illustrated conceptually in FIG. 10. While this calculation of Tᵢ(x, y) is based on the ratio of the target light extraction pattern E_{T}(x, y) to the previous light extraction pattern Eᵢ₋₁(x, y), in other embodiments a different type of comparison between the target light extraction pattern E_{T}(x, y) and the previous light extraction pattern Eᵢ₋₁(x, y) is used.

Optionally, in situations where Eᵢ₋₁(x, y) at a certain point is less than 5% of the average Eᵢ₋₁(x, y) for the light guide, Eᵢ₋₁(x, y) may be set at 5% of the average Eᵢ₋₁(x, y) instead. This advantageously may avoid a numerically unstable situation wherein the ratio of E_{T}(x, y) to Eᵢ₋₁(x, y) approaches infinity. In some embodiments, T₀(x, y) is not constant for all (x, y). For example, in a modified embodiment, T₀(x, y)=0 for points (x, y) wherein E_{T}(x, y)=0. In such embodiments, this helps to speed convergence of Eᵢ(x, y) to E_{T}(x, y). However, in applications where E_{T}(x, y)≠0 for all (x, y), a constant T₀(x, y) is optionally provided for all (x, y).

Continuation of this iterative approach produces second, third, fourth and fifth iterations of the extraction element fields based on the initial uniform field. With subsequent iterations, the resulting spatial light pattern converges to the target light extraction pattern E_{T}(x, y).

As described herein, the damping coefficient α is included to attenuate the destabilizing affects of noise and to improve convergence of the iteratively-produced spatial light pattern to the target spatial light pattern E_{T}(x, y). Example ranges for the coefficient α include α≦1, α≦0.9, α≦0.8, α≦0.7, α≦0.6, α≦0.5, α≦0.4, α≦0.3, α≦0.2, and α≦0.1. In certain embodiments, 0.25 ≦α≦0.80, in other embodiments 0.30 ≦α≦0.75, and in still other embodiments, 0.35 ≦α≦0.70. Still other values for the coefficient α are used in other embodiments. In some embodiments the damping coefficient need not be used. Another technique that is optionally used to reduced the time to convergence of the iteratively-produced spatial light extraction pattern to the target spatial light pattern E_{T}(x, y) is to increase the area over which the illuminance is estimated and correspondingly reduce the number of points (x, y) over which the illuminance is estimated. T(x, y) between the sampled values of (x, y) is then computed using, for example, an interpolation algorithm.

In an example embodiment, the number of iterations i used to converge on the target light extraction pattern E_{T}(x, y) is determined by measuring the error between the light extraction pattern Eᵢ(x, y) obtained on the ith iteration, and the target light extraction pattern E_{T}(x, y). Once this error falls below a predetermined threshold, for example, a “noise floor” as described more fully below, no further iterations are performed. In certain embodiments, the threshold is selected based on the degree to which the target light extraction pattern is to be replicated for a particular application.

The illuminance of the light extraction pattern Eᵢ(x, y) may be modeled based on the array of extractor elements characterized by Tᵢ(x, y) by simulating rays of light through the light guide. Both speed and accuracy of this simulation can be adjusted by selecting an appropriate number of rays. In an example embodiment, a reduced number of rays is traced beginning with the 1st iteration and continuing through the nth iteration, and an increased number of rays is traced beginning with the (n+1)th iteration and continuing through the ith iteration. Optionally, the number of rays is increased when the rate of convergence to E_{T}(x, y) decreases below a predetermined threshold value. Generally, increasing the number of rays traced will advantageously reduce the noise in the calculation, but will also disadvantageously increase computation time required to estimate the light extraction pattern Eᵢ(x, y).

In certain embodiments, the extraction element characteristic T(x, y) refers to the physical spacing of individual extraction elements on the surface of the light guide. In certain embodiments wherein the element spacing is constant across the surface of the light guide, substantial non-uniformity may be apparent in the resulting spatial light extraction pattern, with more light being extracted closer to the light source. However, in certain embodiments wherein the element spacing varies and, for example, decreases as a function of distance from the light source, it is possible to generate a substantially more spatially uniform light extraction pattern. Specifically, by increasing the spacing of the extraction elements in a region proximal to the light source, less light is extracted in the proximal region, and by decreasing the spacing a of the prismatic extraction elements in a region distal to the light source, more light is extracted in the distal region.

In certain embodiments, the spacing as a function of distance from the light source, is iteratively determined using the methods disclosed herein. In such embodiments, relative spacing between adjacent extraction elements is inversely related to the extraction efficiency. Equations such as described above can be used wherein α<0, (for example, −1<α<0). Optionally, in cases where adjacent extraction elements are moved close enough together such that overlap would occur, then the total number of extraction elements can be reduced.

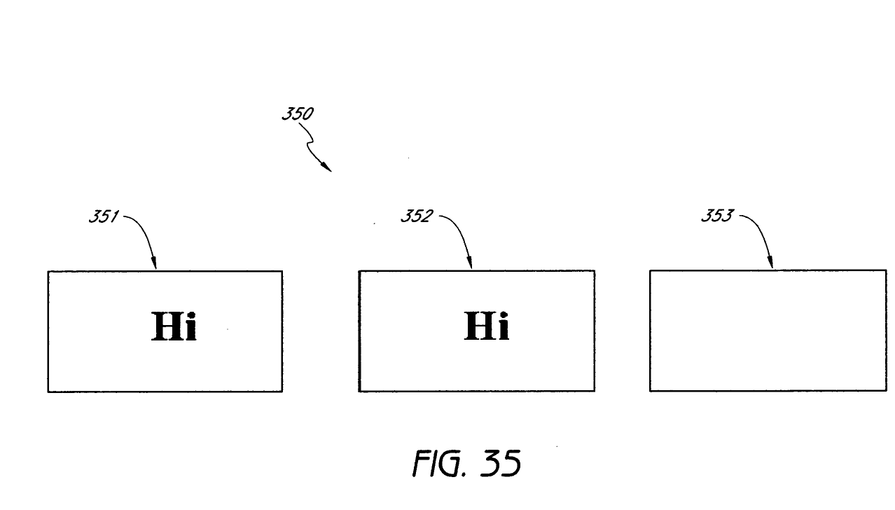

Various embodiments disclosed herein relate to techniques for producing sharp, high resolution images using edge-lit displays. Edge-lit panels can have additional applications. For example, in certain embodiments, as shown in FIG. 35, the reflecting surface behind the extractor pattern may be removed. When the edge light sources are turned off, the display may be transparent thereby enabling viewers to see through the display as indicated by 351. However when the edge light sources are turned on the display may be rendered translucent or opaque as indicated by 352. The opacity of the display may be increased by increasing the luminance of the edge light source to completely obscure or block the view to the other side as indicated by 353. This concept may enable edge-lit displays to be used as privacy filters and/or night lights.

In other embodiments, edge-lit displays comprising high resolution extractor pattern may be disposed with a micro-lens array to provide multiple patterns and create a stereoscopic image. Cylindrical lenslets as well as 2D lens arrays can be used. The micro-lens array may be attached directly to the extractor surface. The observed pattern may vary as a function of the view angle. In some embodiments, merged images can be seen.

In other embodiments, multiple panels may be placed in series. In certain embodiments, different panels can be illuminated with different colors. For example, red, green or blue LEDs can illuminate three different panels thereby providing a high resolution color display.

While the foregoing detailed description discloses several embodiments of the present invention, it should be understood that this disclosure is illustrative only and is not limiting of the present invention. It should be appreciated that the specific configurations and operations disclosed can differ from those described above, and that the apparatus and methods described herein can be used in contexts. Additionally, components can be added, removed, and/or rearranged. Additionally, processing steps may be added, removed, or reordered. A wide variety of designs and approaches are possible.

What is claimed is:

1. A method of defining an array of extractor elements configured to extract light from a light guide to produce a spatial light pattern across the light guide, the method comprising:
receiving an input pattern;
edge enhancement filtering said input pattern thereby producing an edge-enhanced pattern; and
determining an array of extractor elements based on said edge-enhanced pattern.

2. A method of claim 1, wherein said input pattern comprises an image.

3. A method of claim 1, wherein said image comprises a photograph.

4. A method of claim 1, wherein said image comprises graphics.

5. A method of claim 1, wherein said input pattern comprises text.

6. A method of claim 5, wherein said text comprises a letter, number, or character.

7. A method of claim 1, wherein said edge enhancement filtering comprises high pass filtering.

8. The method of claim 1, wherein determining an array of extractor elements comprises an iterative process.

9. The method of claim 1, further comprising smearing the spatial light pattern produced by the array of extractor elements based on said edge-enhanced pattern.

10. The method of claim 9, wherein smearing the spatial light pattern comprises calculating a defocused image of said spatial light pattern.

11. The method of claim 9, wherein smearing the spatial light pattern comprises low pass filtering an image of said spatial light pattern.

12. The method of claim 9, wherein smearing the spatial light pattern comprises under sampling an image of said spatial light pattern.

13. A method of claim 1, further comprising:
(a) calculating a first spatial light pattern produced by the array of extractor elements based on said edge-enhanced pattern, the first spatial light pattern quantifying optical output at the plurality of locations across the light guide;
(b) determining a ratio R of the optical output of the desired spatial light pattern to an optical output of the smeared version of the first spatial light pattern;
(c) determining a modified ratio R′, wherein R′=R^{α} and
(d) determining a characteristic of a second array of extractor elements by scaling a characteristic of the first array of extractor elements by the modified ratio R′.

14. A method of defining an array of extractor elements configured to extract light from a light guide, thereby producing a desired spatial light pattern E_{T} quantifying optical output at a plurality of locations across the light guide, the method comprising:
(a) calculating a smeared version of a first spatial light pattern produced by a first array of extractor elements, the first spatial light pattern quantifying optical output at the plurality of locations across the light guide;
(b) comparing the smeared version of the first spatial light pattern with the desired spatial light pattern; and
(c) determining a characteristic of a second array of extractor elements based on the comparison of the smeared version of the first spatial light pattern and the desired spatial light pattern such that the second array of extractor elements produces an edge enhanced version of the image produced by the first array of extractor elements.

15. The method of claim 14, wherein calculating a smeared version of the first spatial light pattern comprises calculating a defocused image of said first spatial light pattern.

16. The method of claim 14, further comprising:
(a) calculating a smeared version of the second spatial light pattern produced by the second array of extractor elements, the second spatial light pattern quantifying optical output at the plurality of locations across the light guide;
(b) comparing the smeared version of the second spatial light pattern with the desired spatial light pattern; and
(c) determining a characteristic of a third array of extractor elements based on the comparison of the smeared version of the second spatial light pattern and the desired spatial light pattern such that the third array of extractor elements produces an edge enhanced version of the image produced by the second array of extractor elements.

17. The method of claim 14, wherein calculating a smeared version of the first spatial light pattern comprises low pass filtering the first spatial light pattern.

18. The method of claim 14, wherein calculating a smeared version of the first spatial light pattern comprises low pass filtering and defocusing said first spatial light pattern.

19. The method of claim 17, wherein said low pass filtering the first spatial light pattern comprises undersampling.

20. A method of claim 14, wherein the first spatial light pattern is produced by an array of extractor elements determined by an edge-enhanced pattern obtained by edge-enhancement filtering of an input pattern.

21. A method of claim 20, wherein said input pattern comprises an image.

22. A method of claim 20, wherein said image comprises a photograph.

23. A method of claim 20, wherein said image comprises graphics.

24. A method of claim 20, wherein said input pattern comprises text.

25. A method of claim 24, wherein said text comprises a letter, number, or character.

26. A method of claim 14, further comprising:
(a) determining a ratio R of the optical output of the desired spatial light pattern to an optical output of the smeared version of the first spatial light pattern;
(b) determining a modified ratio R′, wherein R′=R^{α} and
(c) determining a characteristic of a second array of extractor elements by scaling a characteristic of the first array of extractor elements by the modified ratio R′.

27. The method of claim 26, wherein−1 <α<0.

28. The method of claim 26, wherein 0 <α<1.

29. The method of claim 26, wherein 0.30 ≦|α|≦0.75.

30. The method of claim 26, further comprising:
(e) calculating a smeared version of the second spatial light pattern produced by the second array of extractor elements, the second spatial light pattern quantifying optical output at the plurality of locations across the light guide;
(f) determining a ratio R″ of the optical output of the desired spatial light pattern to an optical output of the smeared version of the second spatial light pattern;
(g) determining a modified ratio R′″, wherein R′″=(R″)^{α} and
(h) determining a characteristic of a third array of extractor elements by scaling a characteristic of the second array of extractor elements by the modified ratio R′″.

31. A method of defining an array of extractor elements configured to extract light from a light guide, thereby producing a desired spatial light pattern E_{T} quantifying optical output at a plurality of locations across the light guide, the method comprising:
(a) calculating a smoothed version of a first spatial light pattern produced by a first array of extractor elements, the first spatial light pattern quantifying optical output at the plurality of locations across the light guide;
(b) comparing the smoothed version of the first spatial light pattern with the desired spatial light pattern; and
(c) determining a characteristic of a second array of extractor elements based on the comparison of the smoothed version of the first spatial light pattern and the desired spatial light pattern.

32. The method of claim 31, wherein calculating a smoothed version of the first spatial light pattern comprises calculating a defocused image of said first spatial light pattern.

33. The method of claim 31, further comprising:
(a) calculating a smoothed version of the second spatial light pattern produced by the second array of extractor elements, the second spatial light pattern quantifying optical output at the plurality of locations across the light guide;
(b) comparing the smoothed version of the second spatial light pattern with the desired spatial light pattern; and
(c) determining a characteristic of a third array of extractor elements based on the comparison of the smoothed version of the second spatial light pattern and the desired spatial light pattern such that the third array of extractor elements produces an edge enhanced version of the image produced by the second array of extractor elements.

34. The method of claim 31, wherein calculating a smoothed version of the first spatial light pattern comprises low pass filtering the first spatial light pattern.

35. The method of claim 31, wherein calculating a smoothed version of the first spatial light pattern comprises low pass filtering and defocusing said first spatial light pattern.

36. The method of claim 34, wherein said low pass filtering the first spatial light pattern comprises undersampling.

37. A method of claim 31, wherein the first spatial light pattern is produced by an array of extractor elements determined by an edge-enhanced pattern obtained by edge-enhancement filtering of an input pattern.

38. A method of claim 37, wherein said input pattern comprises an image.

39. A method of claim 37, wherein said image comprises a photograph.

40. A method of claim 37, wherein said image comprises graphics.

41. A method of claim 37, wherein said input pattern comprises text.

42. A method of claim 41, wherein said text comprises a letter, number, or character.

43. A method of claim 31, further comprising:
(a) determining a ratio R of the optical output of the desired spatial light pattern to an optical output of the smeared version of the first spatial light pattern;
(b) determining a modified ratio R′, wherein R′=R^{α} and
(c) determining a characteristic of a second array of extractor elements by scaling a characteristic of the first array of extractor elements by the modified ratio R′.

44. The method of claim 43, wherein−1 <α<0.

45. The method of claim 43, wherein 0 <α<1.

46. The method of claim 43, wherein 0.30 ≦α≦0.75.

47. The method of claim 43, further comprising:
(e) calculating a smoothed version of the second spatial light pattern produced by the second array of extractor elements, the second spatial light pattern quantifying optical output at the plurality of locations across the light guide;
(f) determining a ratio R″ of the optical output of the desired spatial light pattern to an optical output of the smeared version of the second spatial light pattern;
(g) determining a modified ratio R′″, wherein R′″=(R)^{α} and
(h) determining a characteristic of a third array of extractor elements by scaling a characteristic of the second array of extractor elements by the modified ratio R′″.
